(19) United States
(12) Patent Application Publication
(10) Pub. No.: US 2024/0331903 A1
(43) Pub. Date: Oct. 3, 2024

(54) HETEROGENEOUS CORE-TYPE MAGNETIC COUPLING DEVICE

(71) Applicant: LG INNOTEK CO., LTD., Seoul (KR)

(72) Inventors: In Seong SOHN, Seoul (KR); Yu Seon KIM, Seoul (KR); Seok BAE, Seoul (KR)

(21) Appl. No.: 18/573,659

(22) PCT Filed: Jun. 29, 2022
(86) PCT No.: PCT/KR2022/009284

§ 371 Date: Dec. 22, 2023

(30) Foreign Application Priority Data
Jun. 29, 2021 (KR) 10-2021-0084729

(51) Int. Cl. H01F 3/02; H01F 1/11; H01F 38/14

(52) U.S. Cl. CPC H01F 3/02; H01F 1/11; H01F 38/14

(57) ABSTRACT

The present invention relates to a magnetic component. The magnetic component comprises: a core including a first flat plate portion, a second flat plate portion, and a pair of outer legs and a center leg disposed between the first flat plate portion and the second flat plate portion; and a coil part at least partially disposed within the core, wherein the first flat plate portion or the second flat plate portion comprises a laminate core in which a plurality of sheets elongated in a first direction are laminated together in a second direction, and each of the outer legs or the center leg comprises a non-laminate core vertically protruding from and attached to one surface of the laminate core.

### TECHNICAL FIELD

The present disclosure relates to a magnetic coupling device, particularly, a magnetic component such as, for example, an inductor or a transformer.

### BACKGROUND ART

With the trend toward slim TVs, there is great demand for slimness of power boards used therefor.

A power factor correction (PFC) inductor has the greatest influence on the thickness of a power board for TVs. Therefore, it is necessary to reduce the thickness of the PFC inductor in order to realize slim TVs.

Here, the thickness of a core is reduced in order to achieve slimness of the PFC inductor. In this case, however, saturation magnetic flux density is reduced, and thus, it is necessary to compensate for DC bias (DCB) reduction. Therefore, two or more PFC inductors are used in one power board in order to achieve slimness.

In recent years, as the slimness of TVs further accelerates, there is demand for ultra-slim TVs, and accordingly, there is great demand for ultra-slim power boards.

In order to achieve ultra-slimness, the thickness of the PFC inductor may be further reduced, and the number of PFC inductors may be further increased for DCB compensation. However, this faces the problem of limited planar space on a board.

Therefore, in particular, there is a need for a novel PFC inductor capable of minimizing DCB reduction despite reduction in the thickness thereof.

### DISCLOSURE

### Technical Problem

An object of the present disclosure is to solve at least one of the above problems with the related art.

In particular, an object of the present disclosure is to provide a magnetic coupling device or a magnetic component having a new type core structure capable of achieving ultra-slimness while occupying a small horizontal space.

### Technical Solution

A magnetic coupling device according to an embodiment of the present disclosure includes a core including a first flat plate part, a second flat plate part, and a pair of outer legs and a center leg disposed between the first and second flat plate parts, the first flat plate part or the second flat plate part includes a plurality of sheets stacked in a first direction, and each of the outer legs or the center leg extends in a second direction different from the first direction.

In at least one embodiment of the present disclosure, the second direction is a direction crossing the plurality of sheets.

In addition, in at least one embodiment of the present disclosure, the plurality of sheets extends in a third direction.

In at least one embodiment of the present disclosure, the third direction and the second direction form an angle of 80 to 100 degrees.

In addition, in at least one embodiment of the present disclosure, the third direction and the second direction form a right angle.

In at least one embodiment of the present disclosure, the sheets have a rectangular shape including linearly disposed edges.

In addition, in at least one embodiment of the present disclosure, the sheets are made of an amorphous crystalline ribbon.

In addition, in at least one embodiment of the present disclosure, the outer legs and the center leg are made of a ferrite-based material.

Here, preferably, the ferrite is a Fe₂O₃-based material.

In at least one embodiment of the present disclosure, the permeability of the first flat plate part and the second flat plate part is two or more times the permeability of the outer legs and the center leg. Preferably, the permeability of the first flat plate part and the second flat plate part is 10,000 H/m or more, and the permeability of the outer legs and the center leg is 2500 H/m or more.

In addition, in at least one embodiment of the present disclosure, the outer legs and the center leg are coupled to the first flat plate part or the second flat plate part via an adhesive layer.

### Advantageous Effects

A magnetic coupling device or a magnetic component having a slimmer structure and capable of meeting requirements for DCB may be obtained. Accordingly, it may be possible to obtain an ultra-slim power board for TVs while minimizing expansion of a horizontal space or without the necessity to expand a horizontal space.

### DESCRIPTION OF DRAWINGS

FIG. 1 illustrates a magnetic component (e.g., PFC inductor) according to an embodiment of the present disclosure.

FIG. 2 is an exploded perspective view of a core included in FIG. 1.

FIG. 3 illustrates a laminated core in FIG. 2.

FIG. 4 illustrates the angular relationship between the laminated core and the non-laminated core in FIG. 2.

FIG. 5 illustrates the relationship between the direction of magnetic force line within the laminated core and an extension direction d1 or stacking direction d2 of core sheets.

### BEST MODE

The present disclosure may make various changes and have various embodiments, and specific embodiments are illustrated and described in the drawings. However, this is not intended to limit the present disclosure to a specific embodiment, and should be understood to include all changes, equivalents, or substitutes included in the spirit and technical scope of the present disclosure.

The suffixes “module” and “unit” used in this specification are only used for denominative distinction between elements, and should not be construed as presuming that the terms are physically and chemically distinguished or separated or may be distinguished or separated in that way.

Although terms including ordinal numbers, such as “first”, “second”, etc., may be used herein to describe various elements, the elements are not limited by these terms. These terms are only used to distinguish one element from another.

The term “and/or” is used to include any combination of a plurality of items that are the subject matter. For example, “A and/or B” inclusively means all three cases such as “A”, “B”, and “A and B”.

It will be understood that when a component is referred to as being “connected to” or “coupled to” another component, it may be directly connected to or coupled to another component, or intervening components may be present.

In the description of the embodiments, it will be understood that when an element, such as a layer (film), a region, a pattern or a structure, is referred to as being “on” or “under” another element, such as a substrate, a layer (film), a region, a pad or a pattern, the term “on” or “under” means that the element is directly on or under another element or is formed such that an intervening element may also be present. In addition, it will also be understood that criteria of “on” or “under” is on the basis of the drawing for convenience unless otherwise defined due to the characteristics of each of components or the relationship therebetween. The term “on” or “under” is used only to indicate the relative positional relationship between components and should not be construed as limiting the actual positions of the components. For example, the phrase “B on A” merely indicates that B is illustrated in the drawing as being located on A, unless otherwise defined or unless A must be located on B due to the characteristics of A or B. In an actual product, B may be located under A, or B and A may be disposed in a leftward-rightward direction.

In addition, the thickness or size of a layer (film), a region, a pattern, or a structure shown in the drawings may be exaggerated, omitted, or schematically drawn for the clarity and convenience of explanation, and may not accurately reflect the actual size.

The terminology used herein is for the purpose of describing particular embodiments only and is not intended to be limiting of exemplary embodiments of the disclosure. As used herein, the singular forms are intended to include the plural forms as well, unless the context clearly indicates otherwise. It will be further understood that the terms “include” or “have”, when used herein, specify the presence of stated features, integers, steps, operations, elements, components, or combinations thereof, but do not preclude the presence or addition of one or more other features, integers, steps, operations, elements, components, or combinations thereof.

Unless defined otherwise, all terms used herein, including technical or scientific terms, have the same meanings as commonly understood by one of ordinary skill in the art to which the present disclosure belongs. Terms such as those defined in commonly used dictionaries should be interpreted as having meanings consistent with the meanings in the context of the related art, and unless explicitly defined in this application, the terms should not be interpreted as having ideal or excessively formal meanings.

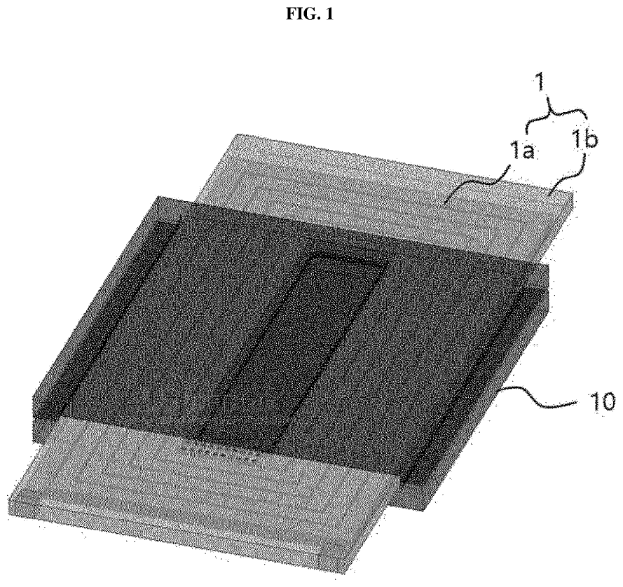

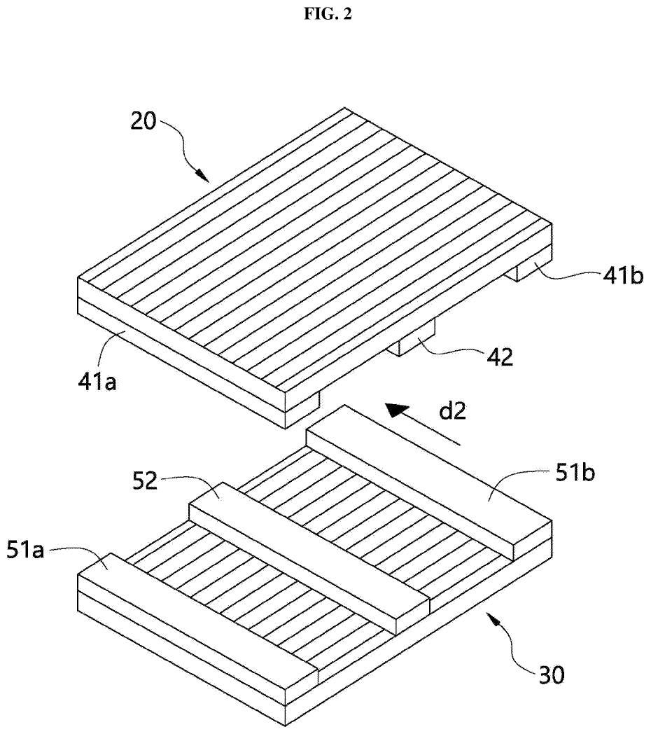

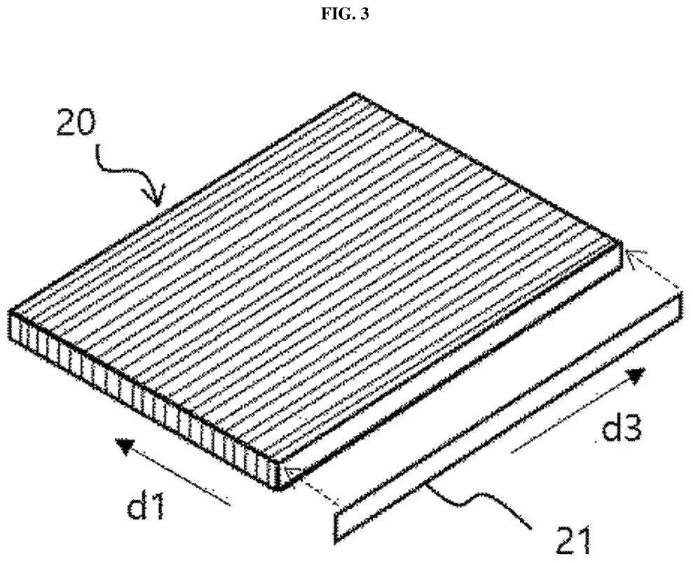

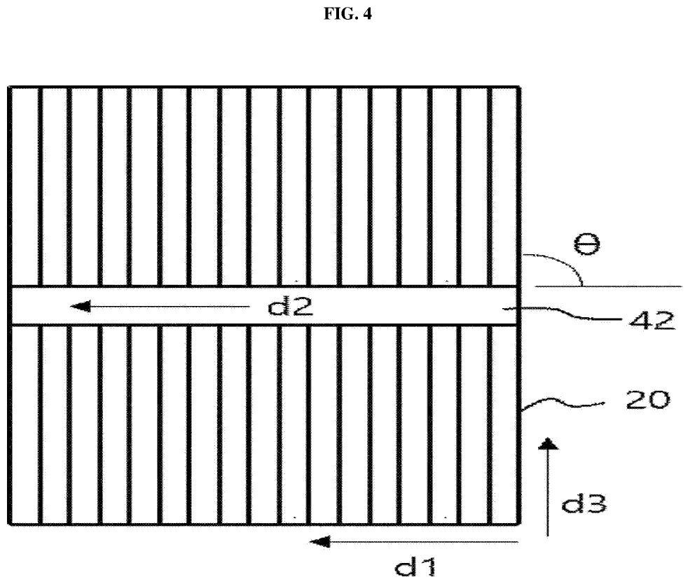

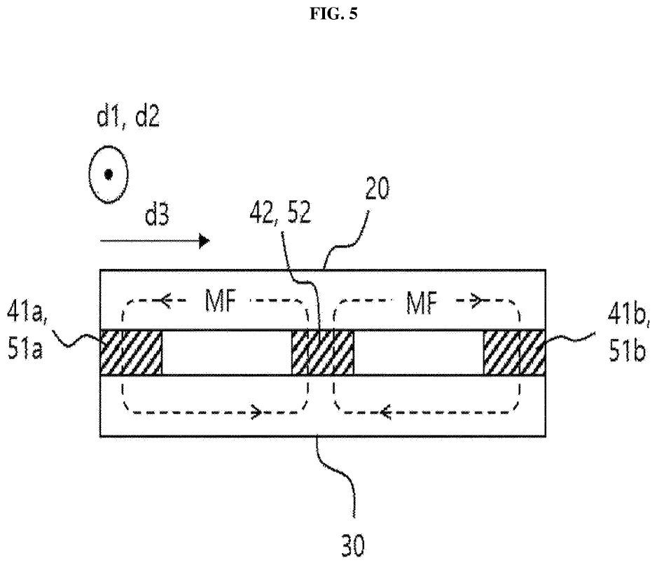

As one embodiment of the present disclosure, FIG. 1 illustrates a PFC inductor, FIG. 2 is an exploded perspective view of a core included in FIG. 1, and FIG. 3 illustrates a laminated core in FIG. 2. In addition, FIG. 4 illustrates the angular relationship between the laminated core and the non-laminated core in FIG. 2, and FIG. 5 illustrates the relationship between the direction of magnetic force line within the laminated core and an extension direction d1 or stacking direction d2 of core sheets.

As shown in FIG. 1, the PFC inductor of this embodiment includes a core 10 and a coil unit 1. Illustratively, the coil unit 1 includes a primary coil unit 1a and a secondary coil unit 1b. Here, for example, the coil may be a windable conductor, such as a USTC wire, a triple insulated wire, or a copper plate, or a coil-shaped conductor.

As shown in FIG. 2, the core 10 includes a first flat plate part 20, a second flat plate part 30, and outer and center legs disposed between the first and second flat plate parts 20 and 30.

As shown in FIG. 3, the first flat plate part 20 is a laminated core formed by stacking magnetic sheets 21, which extend in a third direction d3, in a first direction d1.

In addition, a pair of first outer legs 41a and 41b and a first center leg 42 are attached as non-laminated cores to one flat surface of the first flat plate part 20.

Preferably, the first flat plate part 20 and the first outer legs 41a and 41b or the first center leg 42 are coupled to each other by means of a resin adhesive. The resin layer may be disposed on the entire surface of the first flat plate part 20, or portions of the resin layer may be disposed so as to be spaced apart from each other by a distance between the outer legs and the center leg.

In this embodiment, the first outer and center legs 41a, 41b, and 42 are elongated in a second direction d2, and a space, in which a coil of the coil unit 1 is disposed, is defined between the first outer and center legs 41a, 41b, and 42.

Unlike the laminated core, the first outer and center legs 41a, 41b, and 42 may be made of, for example, predetermined magnetic powders through sintering and firing.

In this embodiment, the third direction d3, which is the longitudinal direction of the magnetic sheet 21, and the second direction d2, which is a longitudinal direction in which the first outer and center legs 41a, 41b, and 42 extend, form an angle θ of 80 to 100 degrees. More preferably, the angle is a right angle.

FIG. 5 illustrates the relationship between the direction of a magnetic force line within the core 10, the third direction d3, and the first direction d1. The longitudinal direction in which the sheet 21 extends, that is, the third direction d3, is parallel to the direction of magnetic flux within the laminated core. Here, when the longitudinal direction in which the sheet 21 extends is not the third direction d3 but the first direction d1, the stacked direction becomes the third direction d3. Therefore, the magnetic flux within the laminated core passes across the stacked sheets 21, and thus, the magnetic force line passes through not only the respective sheets 21 but also interface layers formed by the respective adhesive layers between the sheets 21, whereby loss occurring on the interfaces is undesirably increased. As can be seen from the experimental results to be described later, for example, when the extension direction of the sheet 21 is set to the first direction d1, that is, when the stacking direction thereof is set to the third direction d3, there is a problem in that inductance is greatly reduced.

For this reason, as described above, the longitudinal direction in which the first outer and center legs 41a, 41b, and 42 extend and the longitudinal direction in which the core sheet 21 extends preferably form an angle of 80 degrees to 100 degrees, and more preferably form a right angle.

In this embodiment, the second flat plate part 30 has exactly the same structure as the first flat plate part 20, and second outer legs 51a and 51b and a second center leg 52 have the same structure as the first outer legs 41a and 41b and the first center leg 42. Therefore, description thereof will be omitted, but the disclosure is not necessarily limited thereto.

In addition, the second flat plate part 30 and the second outer legs 51a and 51b or the second center leg 52 may also be coupled to each other by means of a resin adhesive layer.

Meanwhile, preferably, the sheet 21 is a metal sheet 21 including an amorphous crystalline ribbon component.

In addition, the non-laminated core is a ferrite-based core, preferably, a Fe₂O₃-based ferrite core 10.

In addition, preferably, the permeability of the laminated core is two or more times the permeability of the non-laminated core.

In this regard, in this embodiment, the permeability of the laminated core is 10,000 H/m or more, and the saturation magnetic flux density thereof is 1.0 T or more. The permeability of the non-laminated core is 2500 H/m or more, and the saturation magnetic flux density thereof is 0.4 T or more.

Hereinafter, comparison in inductance, magnetic flux distribution, and DCB characteristics between a conventional inductor (comparative example) and embodiments of the present disclosure will be described.

### Comparative Example (Conventional Core Structure)

Core Material: Ferrite
Core Size: Flat Plate Part 48×50 (unit mm, the same hereinafter), Center Leg 9×50, Outer Leg 4×50

### Embodiment 1

Core Material: Laminated Core—Ribbon, Non-laminated Core—Ferrite
Laminated Core Direction: Extension Direction of Sheet 21—Third Direction, Stacking Direction-First Direction
Non-laminated Core Extension Direction—Identical to First Direction (i.e., Perpendicular to Third Direction)
Core Size: Flat Plate Part 48×50 (unit mm, the same hereinafter), Center Leg 9×50, Outer Leg 4×50

### Embodiment 2

Core Material: Laminated Core—Ribbon, Non-laminated Core—Ferrite
Laminated Core Direction: Extension Direction of Sheet 21—First Direction, Stacking Direction—Third Direction
Non-laminated Core Extension Direction—Identical to First Direction (i.e., Perpendicular to Stacking Direction)
Core Size: Flat Plate Part 48×50 (unit mm, the same hereinafter), Center Leg 9×50, Outer Leg 4×50

The above comparison in inductance, magnetic flux distribution, and DCB characteristics between the comparative example and the embodiments is shown in the following table.

TABLE 1
<Comparison in Inductance, Magnetic Flux
Distribution, and DCB Characteristics>

| | Inductance | Magnetic Flux | |
|---|---|---|---|
| Classification | [μH] | Distribution [T] | DCB [A] |
| Comparative Example | 89.09 | 0.48 | 16 |
| Embodiment 1 | 74.04 | 0.72 | 20 |
| Embodiment 2 | 29.3 | 0.72 | |

As shown in the table above, it can be seen that the magnetic flux distribution is greatly improved in Embodiments 1 and 2, and in particular, the DCB in Embodiment 1 is increased by 25% compared to that in the comparative example.

In addition, the inductance in Embodiment 2 is greatly reduced compared to that in Embodiment 1. This means that, when the longitudinal direction d1 in which the sheet 21 extends and the extension direction d3 of the non-laminated core are perpendicular to each other, the inductance characteristics are improved compared to when not perpendicular to each other.

According to the embodiments of the present disclosure, since the heterogeneous core structure constituted by the laminated core and the non-laminated core is used, the saturation magnetic flux of the magnetic component is mitigated, and the DCB performance is improved.

As a result, the number of magnetic components for one power board may be reduced, and accordingly, it may be possible to achieve ultra-slimness while reducing material costs.

In addition, the performance of the magnetic component may be adjusted depending on the placement of the laminated core and the non-laminated core. In the case of using only the conventional laminated core, the laminated core has a problem in that the performance thereof is deteriorated due to ribbon breakage during cutting, trimming, and processing. Therefore, it is impossible to apply the laminated core to a small magnetic component through a shaping process. However, this embodiment does not have the above problems because it is not necessary to process the laminated core.

Meanwhile, in this embodiment, the PFC inductor has been described by way of example. However, this embodiment may also be applied to other types of magnetic coupling devices. For example, the present disclosure may be applied to magnetic coupling devices such as transformers and filters, without being limited thereto.

### Mode for Invention

Various embodiments have been described in the best mode for carrying out the disclosure.

### INDUSTRIAL APPLICABILITY

A magnetic coupling device according to embodiments may be used for TVs and the like.

1. A magnetic coupling device, comprising a core including a first flat plate part, a second flat plate part, and a pair of outer legs and a center leg disposed between the first and second flat plate parts,
wherein the first flat plate part or the second flat plate part includes a plurality of sheets stacked in a first direction, and
wherein each of the outer legs or the center leg extends in a second direction different from the first direction.

2. The magnetic coupling device according to claim 1, wherein the second direction is a direction crossing the plurality of sheets.

3. The magnetic coupling device according to claim 1, wherein the plurality of sheets extends in a third direction.

4. The magnetic coupling device according to claim 3, wherein the third direction and the second direction form an angle of 80 to 100 degrees.

5. The magnetic coupling device according to claim 1, wherein the sheets have a rectangular shape including linearly disposed edges.

6. The magnetic coupling device according to claim 1, wherein the sheets are made of an amorphous crystalline ribbon.

7. The magnetic coupling device according to claim 1, wherein the outer legs and the center leg are made of a ferrite-based material.

8. The magnetic coupling device according to claim 1, wherein permeability of the first flat plate part and the second flat plate part is two or more times permeability of the outer legs and the center leg.

9. The magnetic coupling device according to claim 8, wherein the permeability of the first flat plate part and the second flat plate part is 10,000 H/m or more, and the permeability of the outer legs and the center leg is 2500 H/m or more.

10. The magnetic coupling device according to claim 1, wherein the outer legs and the center leg are coupled to the first flat plate part or the second flat plate part via an adhesive layer.

11. The magnetic coupling device according to claim 1, wherein, the first flat plate part is a laminated core.

12. The magnetic coupling device according to claim 1, wherein the pair of outer legs and center leg are non-laminated cores.

13. The magnetic coupling device according to claim 1, wherein the outer and center legs includes a sintered and fired predetermined magnetic powders.

14. The magnetic coupling device according to claim 1, further comprising a coil unit, at least portion of the coil unit being disposed in the core.

15. The magnetic coupling device according to claim 14, wherein the at least portion of the coil unit is disposed in a space defined between the outer and center legs.

16. The magnetic coupling device according to claim 14, wherein the coil unit is a windable conductor or a coil-shaped conductor.

17. The magnetic coupling device according to claim 3, wherein the third direction is parallel to a direction of magnetic flux within the first flat plate part.

18. The magnetic coupling device according to claim 4, wherein the third direction and the second direction form a right angle.

19. The magnetic coupling device according to claim 7, wherein the ferrite-based material includes a Fe₂O₃-based material.

20. The magnetic coupling device according to claim 9, wherein a saturation magnetic flux density of the second flat plate part is 1.0 T or more, and
a saturation magnetic flux density of the pair of outer legs and a center leg is 0.4 T or more.
